(19) United States
(12) Patent Application Publication
(10) Pub. No.: US 2023/0334694 A1
(43) Pub. Date: Oct. 19, 2023

(54) GENERATING SENSOR SPATIAL DISPLACEMENTS BETWEEN IMAGES USING DETECTED OBJECTS

(71) Applicant: Opsis Health, Inc., Golden, CO (US)

(72) Inventors: Oliver Peter King-Smith, Fremont, CA (US); Kevin Patrick Grundy, Golden, CO (US)

(21) Appl. No.: 18/302,966

(22) Filed: Apr. 19, 2023

Related U.S. Application Data
(60) Provisional application No. 63/332,657, filed on Apr. 19, 2022.

(51) Int. Cl. G06T 7/73

(52) U.S. Cl. CPC G06T 7/73; G06T 2207/10012; G06T 2207/30244

(57) ABSTRACT

Systems and methods for generating sensor spatial displacements between images using detected objects are provided. According to one embodiment, multiple images are received of an objective scene containing an object. The multiple images are captured by a sensor from different viewpoints. One or more differences is estimated between a first coordinate system associated with the object in a first image of the multiple images and a second coordinate system associated with the object in a second image of the multiple of images. Based on the one or more differences, a displacement is determined between a first position of the sensor from which the first image was captured and a second position of the sensor from which the second image was captured.

### CROSS-REFERENCE TO RELATED APPLICATIONS

This application claims the benefit of priority of US Provisional Application No. 63/332,657, filed Apr. 19, 2022, the contents of which are hereby incorporated by reference in their entirety for all purposes.

### BACKGROUND

### Field

Various embodiments of the present disclosure generally relate to imaging, digital image processing, and camera geometry. In particular, some embodiments relate to approaches for determining information regarding camera poses from images of an object generated by one or more cameras at different positions (from different viewpoints). For example, the spatial displacement of a sensor that captured a first image from a first position may be determined relative to the same or a different sensor that captured a second image from a second position.

### Description of the Related Art

The ability of a camera to know its position (pose) has many applications. A useful application is to know where a camera is located with respect to an object being photographed (e.g., image taken). Cameras may incorporate special sensors such as lidar (e.g., “time of flight”) or radar to facilitate the generation of the camera’s pose. Alternatively, a camera may incorporate a second imager (e.g., an image sensor) spaced apart from another imager to generate a known baseline between multiple imagers (stereo) to facilitate the estimation of a camera pose.

### SUMMARY

Systems and methods are described for generating sensor spatial displacements between images using detected objects. According to one embodiment, multiple images are received an objective scene containing an object. The multiple images are captured from different viewpoints, for example, by the same sensor or different sensors. At least one of a relative rotation or translation of the object is estimated between a first image of the multiple images and a second image of the multiple images. A transform mapping between the first image and the second image is estimated based on at least one of the relative rotation or the translation. Based on the transform mapping, a fundamental matrix between the first image and the second image is calculated.

According to another embodiment, multiple images are received of an objective scene containing an object. The multiple images are captured by a sensor from different viewpoints. One or more differences is estimated between a first coordinate system associated with the object in a first image of the multiple images and a second coordinate system associated with the object in a second image of the multiple of images. Based on the one or more differences, a displacement is determined between a first position of the sensor from which the first image was captured and a second position of the sensor from which the second image was captured.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an exemplary block diagram showing major elements for processing an image in accordance with an embodiment of the present disclosure.

FIG. 2 is an exemplary block diagram showing major elements for determining a fundamental matrix between two images in accordance with an embodiment of the present disclosure.

FIG. 3 illustrates a generalization of a computing element, system or device that may be used to implement any or all processing stages, estimators, transformers, etc. shown in FIG. 1 and/or FIG. 2.

FIG. 4 illustrates a sequence of sensor poses wherein an overlayed coordinate system is tracked from image to image to determine the spatial displacement of the sensor in accordance with an embodiment of the present disclosure.

FIG. 5 illustrates an example of performing pose estimation through a coordinate system estimator in accordance with an embodiment of the present disclosure.

FIG. 6 illustrates an example of a direct pose estimator in accordance with an embodiment of the present disclosure.

FIG. 7 is a flow diagram illustrating a set of operations for calculating a fundamental matrix between two images in accordance with an embodiment of the present disclosure.

FIG. 8 is a flow diagram illustrating a set of operations for estimating the spatial displacement of a sensor through changes in an overlaid coordinate system in accordance with an embodiment of the present disclosure.

### DETAILED DESCRIPTION

Systems and methods are described for generating sensor spatial displacements between images using detected objects. For various applications, it is helpful to have information regarding a pose of a camera corresponding to a given image. Some prior approaches rely on the use of additional sensors and/or imagers incorporated into a camera to facilitate pose estimation; however, this generally increases the cost and complexity.

In lieu of including additional sensors to provide camera pose estimations, various embodiments described herein provide unique and cost-effective alternatives by making use of a shape detector. Objects with known shapes, such as a plate, bowl or glass (e.g. circle, cylinder, square) provide coordinate references that mathematically shift in a consistent way with different camera poses. Consequently, as described further below, coordinate transformations coupled with a known object’s shape may be used to estimate camera poses based upon the deterministic way in which a known shape appears in an objective scene captured from different poses. For example, in one embodiment, fundamental matrices may be generated between two images based on one or more objects detected within the images.

While for purposes of illustration various examples are described in which images include an object (e.g., a plate) having a perimeter or outer boundary of known shape (e.g., a circle, sphere, square, box, etc.), it is to be appreciated the pose estimation approaches described herein are equally applicable to other objects (e.g., a cup, a bowl, or other vessel on which or in which food may be served, a placemat, or the like) and/or other known shapes (e.g., a rectangle, a triangle, etc.).

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

The terms “comprises” and/or “comprising,” as used in this specification and the appended claims, specify the presence of stated features, integers, steps, operations, elements, and/or components, but do not preclude the presence or addition of one or more other features, integers, steps, operations, elements, components, and/or groups thereof. The term “exemplary” refers to an example, not a preference or requirement.

As used herein, the term “communication” and “in communication” is meant to refer to components of the device that work together, but are not necessarily connected to each other. In addition, there may be additional processing elements between the components.

As used herein, the term “image” refers to a set of data that represents a three-dimensional (3D) scene. The image may be a two-dimensional (2D) representation, such as a digital photograph or video. The image can also be a 3D representation of a scene such as a point cloud generated by a LIDAR or structured light system. It can also be a 3D map of the scene as generated by a stereo camera or 3D camera.

As used herein, an “imaging device” refers to a device that is capable of recording, storing, and/or transmitting an image. Non-limiting examples of imaging devices include mechanical, digital, or electronic viewing devices, camera modules, smartphone cameras, still cameras, camcorders, and motion picture cameras.

As used herein an “image sensor” or simply a “sensor” generally refers to a device that converts incoming light (photons) into an electrical signal that can be viewed, analyzed, or stored. Non-limiting examples of image sensors include a charged-coupled device (CCD) sensor and a complementary metal-oxide semiconductor (CMOS) sensor. A sensor may comprise additional input devices which gather or collect additional information such as the tilt, acceleration, rotation, or velocity of the sensor.

As used herein “pose estimation” generally refers to determining or estimating the position and orientation (pose) of an imaging device relative to an object contained within an image (or vice-versa). In various embodiments, the correspondences between 2D image pixels (and thus camera rays) and 3D object points (from the world) may be used to compute the pose.

As used herein “standard pose” generally refers to the pose of an object by an imager wherein the object is viewed by the imager in a straight on manner. For example, taking an image of a circular plate on a table from directly above the plate wherein the plate appears in the image as an undistorted circle is considered as the standard pose.

As used herein “homography estimation” generally refers to a technique used in computer vision and image processing to find the relationship between two images of the same scene, but captured from different viewpoints. In other words, two 2D images are related by a homography (H), if both view the same plane from a different angle. Homography may be used to align images, correct for perspective distortions, or perform image stitching.

As used herein a “transform” generally refers to an operation that processes an input image and produces an output image. Non-limiting examples of a transform for converting a given pose to a standard pose include affine transformations and Hough transformations.

### Example Image Processing

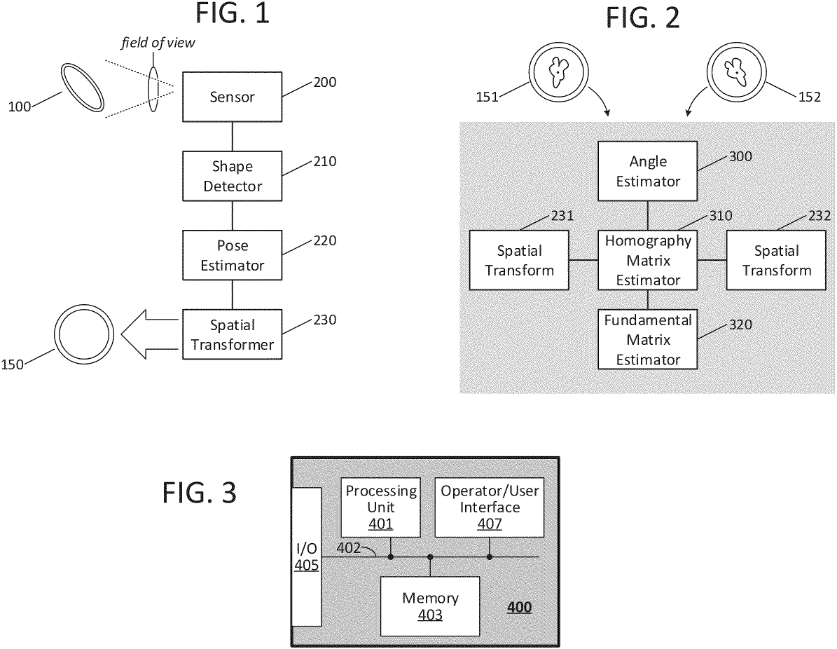

FIG. 1 is an exemplary block diagram showing major elements for processing an image in accordance with an embodiment of the present disclosure. According to one embodiment, the major elements (e.g., a sensor 200, a shape detector 210, a pose estimator 220, and a spatial transformer 230) may be included within an imaging device

In the context of the present example, an object 100 (e.g., a plate having a known outer boundary shape, for example, a circle) may be observed with the sensor 200 which, in turn, communicates captured images to the shape detector 210. The shape detector 210 can identify objects in any spatial orientation. The pose estimator 220 is in communication with the shape detector 210. The pose estimator 220 determines a transformation of an object in a standard pose 150 (e.g., observed) to the object 100. The spatial transformer 230 generates the transform of the object 100 to the standard pose 150.

The standard pose 150 may represent a spatial orientation of a known object type when the object is viewed “straight on” and therefore its shape has no deformation from a known shape of the known object type. For example, the standard pose 150 may represent an orientation of an object as viewed by the sensor 200 when a plane of the sensor 200 is parallel to a plane of the object and the sensor 200 is directly over the object.

Still referring to FIG. 1, the sensor 200 acquires an image of a scene containing the object 100. The shape detector 210 analyses the image from the sensor 200 looking for a known object type. When an object is detected, the shape detector 210, which is in communication with the pose estimator 220, develops a transformation of the known object in the standard pose 150 to the location and orientation of the object 100 as detected by the sensor 200.

Still referring to FIG. 1, according to one embodiment, the shape detector 210 and pose estimator 220 may be combined as a single neural network where the input is the image acquired by the sensor 200 and the output is a transformation from the standard pose 150 to the object 100.

According to one embodiment, in which the known object type is a circular plate, the known object type may be detected with the use of a Convolution Neural Network (CNN). The CNN may be used to take the image acquired by sensor 200 and output a set of parameters (e.g., 5 parameters (sₓ,s_{y},tₓ,t_{y},Θ)). These parameters can then be applied as an affine transformation to the standard pose 150, in this case, a single circle to the outer edge of the plate.

In the context of the present example, the affine transformation that describes the spatial transformation of the spatial transformer 230 is given by the following matrices:

$$\left[\begin{matrix}{s}_{x} & 0 & {t}_{x} \\ 0 & {s}_{y} & {t}_{y} \\ 0 & 0 & 1\end{matrix}\right] \left[\begin{matrix}c o s \left(θ\right) & - s i n \left(θ\right) & 0 \\ s i n \left(θ\right) & c o s \left(θ\right) & 0 \\ 0 & 0 & 1\end{matrix}\right]$$

Training the CNN can be accomplished by using a continuous differential affine transformation. A non-limiting example of the use of a continuous differential affine transformation to train a CNN is described in a paper entitled “Spatial Transformer Networks” by Max Jaderberg, Karen Simonyan, Andrew Zisserman, Koray Kavukcuoglu by Deep Mind in 2015, which is hereby incorporated by refence in its entirety for all purposes.

To train the CNN, an object in standard pose 150 can be used with the following loss function:

$$L = {\sum }_{x} {\sum }_{y} p r e d \left(x , y\right) \left(1 - t a r g e t \left(x , y\right)\right)$$

where pred(x,y) is the image acquired by the sensor 200 and target(x,y) is an image of the object 100 in standard pose 150.

### Example Determination of the Fundamental Matrix Between Two Images

FIG. 2 is an exemplary block diagram showing the major elements for determining a fundamental matrix between two images in accordance with an embodiment of the present disclosure. In the context of the present example, if one object is seen in two images that have been transformed to respective standard poses 151, 152 there can be a rotation between the two images. An angle estimator 300 can then estimate the planar rotation required to align the two standard poses 151, 152.

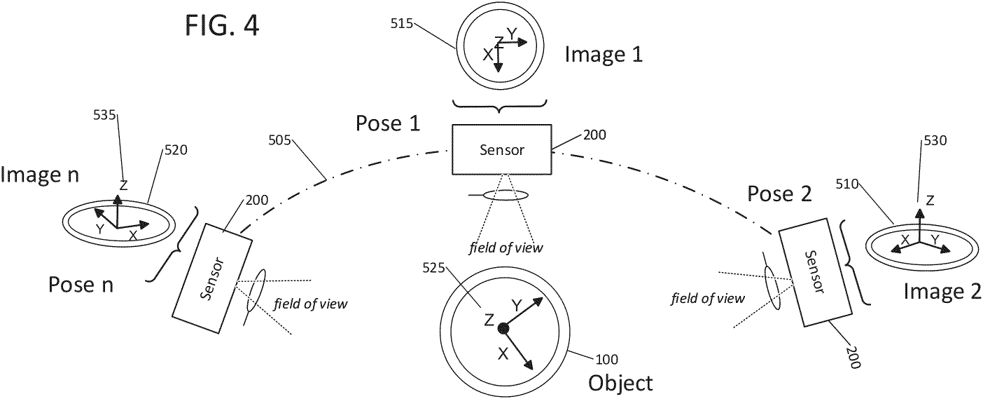

Still referring to FIG. 2, once the angle estimator 300 has estimated the planar rotation, a transfer mapping (e.g., a homography matrix) can be calculated by a homography matrix estimator 310 between the two images by combining the spatial transformations (e.g., spatial transform 231 and spatial transform 232) derived by a spatial transformer (e.g., spatial transformer 230) and the planar angle. Once the homography matrix has been calculated, a fundamental matrix estimator 320 can calculate the fundamental matrix between the two images. According to one embodiment, if affine transformations are used by the spatial transformer, the homography matrix can be calculated by the exemplary matrices shown below:

$$\left[\begin{matrix}{s}_{x}^{1} c o s \left({θ}^{1}\right) & - {s}_{x}^{1} s i n \left({θ}^{1}\right) & {t}_{x}^{1} \\ {s}_{x}^{1} s i n \left({θ}^{1}\right) & {s}_{x}^{1} c o s \left({θ}^{1}\right) & {t}_{y}^{1} \\ 0 & 0 & 1\end{matrix}\right] \left[\begin{matrix}c o s \left(ϕ\right) & - s i n \left(ϕ\right) & 0 \\ s i n \left(ϕ\right) & c o s \left(ϕ\right) & 0 \\ 0 & 0 & 1\end{matrix}\right] \left[\begin{matrix}\frac{c o s \left({θ}^{2}\right)}{{s}_{x}^{2}} & \frac{s i n \left({θ}^{2}\right)}{{s}_{y}^{2}} & \left(\frac{- {t}_{x}^{2} c o s \left({θ}^{2}\right)}{{s}_{x}^{2}} - \frac{{t}_{y}^{2} s i n \left({θ}^{2}\right)}{{s}_{y}^{2}}\right) \\ - \frac{s i n \left({θ}^{2}\right)}{{s}_{y}^{2}} & \frac{c o s \left({θ}^{2}\right)}{{s}_{x}^{2}} & \left(\frac{- {t}_{x}^{2} s i n \left({θ}^{2}\right)}{{s}_{x}^{2}} - \frac{{t}_{y}^{2} c o s \left({θ}^{2}\right)}{{s}_{y}^{2}}\right) \\ 0 & 0 & 1\end{matrix}\right]$$

Where s¹, t¹, Θ¹ are the affine transformation values for the first image, Ø is the planar angle between the 2 standard poses (151,152), and s², t², θ² are the transformation values for the second image. The various processing stages, estimators, transformers and the like described above with reference to FIGS. 1-2 and the processing described below with reference to FIGS. 4-7 may be implemented in the form of executable instructions stored on a machine readable medium and executed by one or more processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by a computer system, such as the computing element, system or device described below with reference to FIG. 3 below.

### Example Fundamental Matrix Calculation

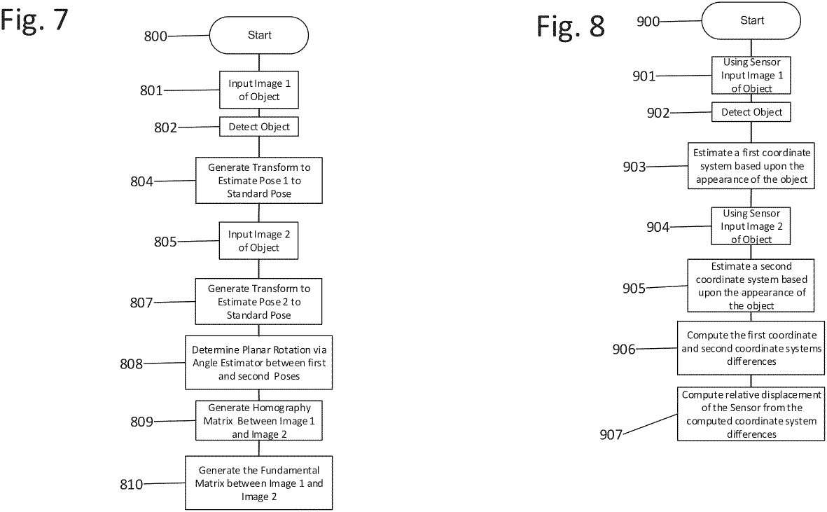

FIG. 7 is a flow diagram 800 illustrating a set of operations for calculating a fundamental matrix between two images in accordance with an embodiment of the present disclosure. The processing described with reference to FIG. 7 may be performed by a combination of the various processing stages, estimators, transformers and the like shown in FIGS. 1 and 2. The processing described with reference to FIG. 7 may be collocated with an imaging device that captured one or both of the two images or may be performed by a computing element, device, or system separate from a first imaging device that captured a first of the two images and a second imaging device that captured a second of the two images.

At block 801, a first image (e.g., image 1) of an object is received as an input. As discussed above, the object may be a known object (e.g., a plate, a bowl, a cup, or the like) having a known shape (e.g., a circle). The first image may be in the form of raw image data representing an objective scene containing the object. Depending on the particular implementation, the first image may represent a digital photograph, a digital image, or a single frame extracted from a digital video. The first image is assumed to have been captured by a sensor (e.g., sensor 200) of a first imaging device while in a first unknown position (pose).

At block 802, the object is detected within the first image, for example, by a shape detector (e.g., shape detector 210 in FIG. 1). Given a known shape of the object when in a standard pose (e.g., standard pose 100, 151, or 152), computer vision techniques may be used to detect the object regardless of the position (pose) of the first imaging device when the image was captured and the resulting spatial orientation and/or deformation of the object within the first image. For example, a CNN may be used to detect the known object type.

At block 804, a transform to estimate pose 1 to a first standard pose (e.g., standard pose 151) is generated. According to one embodiment, based on pose 1 and the first standard pose, a spatial transformer (e.g., spatial transformer 230), for example, in the form of a CNN may be used to generate a transform (e.g., an affine transformation) that when applied to pose 1 results in the first standard pose.

At block 805, a second image (e.g., image 2) of the object is received as an input. As above, the second image may be in the form of raw image data representing an objective scene containing the object and may represent a digital photograph, a digital image or a single frame extracted from a digital video. The second image is assumed to have been captured by a sensor (e.g., sensor 200) of the first imaging device or a second imaging device while in a second unknown position (pose).

At block 807, similar to block 804, a transform to estimate pose 2 to a second standard pose (e.g., standard pose 151) is generated. According to one embodiment, based on pose 2 and a second standard pose, a spatial transformer (e.g., spatial transformer 230), for example, in the form of a CNN may be used to generate a transform (e.g., an affine transformation) that when applied to pose 2 results in the second standard pose

At block 808, the planar rotation between the first standard pose and the second standard pose is determined. For example, an angle estimator (e.g., angle estimator 300) may be used to estimate the planar rotation to align the first standard pose and the second standard pose.

At block 809, a transform mapping (e.g., a homography matrix) is generated between image 1 and image 2. The transform mapping may be generated based on at least one of a relative rotation or translation between pose 1 and pose 2, for example, based on the estimates determined in blocks 804, 807, and 808.

At block 810, a fundamental matrix is generated between image 1 and image 2. The fundamental matrix may be generated based at least in part on the transform mapping generated in block 809

While in the context of various examples, a number of enumerated blocks are included, it is to be understood that other examples may include additional blocks before, after, and/or in between the enumerated blocks. Similarly, in some examples, one or more of the enumerated blocks may be omitted and/or performed in a different order.

### Example Computer System

FIG. 3 illustrates a computing element, system or device 400 that may be used to implement any or all processing stages, estimators, transformers and the like shown in FIGS. 1 and 2 in accordance within an embodiment of the present disclosure.

As shown, computing element 400 includes a processing unit 401 formed by one or more general purpose or special-purpose processors (e.g., digital signal processor having a multiply-accumulate function for rapid convolutional operation, neural network, etc.), memory 403 for storing program code executed by the processing unit to implement the various processing stages (e.g., shape detector, pose estimator, spatial transform, angle estimator, homography matrix estimator, fundamental matrix estimator, etc.) of the above-described embodiments, and also to store the data streamed through the computing element 400 (i.e., input and output image data streams or portions thereof, various image characterizing information (e.g., pose estimation coefficients, object recognition information, etc.).

Computing element 400 further includes one or more input and/or output (I/O) ports 405 for receiving raw image data input and outputting processed image data, and an optional user interface 407 to present and receive information to a human or artificial operator (e.g., another computing device within a host system) and thus enable operator control of system operation (e.g., set configuration, programmable values, etc.) as well as to interact with the larger host system in a manner intended by its core function (e.g., image rendering system, object recognition system, weight/volume/caloric-content estimation, etc.). It is to be appreciated that the user interface may alternatively be implemented through one or more of I/O ports 405. Also, numerous other functional blocks (not specifically shown) may be provided within computing element 400 according to its core function (and the computing system itself may be a component in a larger host device, appliance or network of devices/appliances). For example, when implemented within a smartphone, personal computing device, image display appliance, etc., computing element 400 may be accompanied by or incorporate wireless (radio-frequency) communication circuitry, image rendering display and various transducers (e.g., microphones, speakers, sensors, etc.).

Still referring to FIG. 3, the functional blocks within computing element 400 are coupled to one another via communication path 402 which, though conceptually depicted as a single shared bus, may include any number of shared or dedicated buses or signaling links (including wireless links) to convey information according to various proprietary or standardized protocols. More generally, the functional blocks shown may be interconnected in a variety of different topologies and individually be implemented by a variety of different underlying technologies and architectures. With regard to the memory architecture, for example, multiple different classes of storage may be provided within memory 403 to store different classes of data. For example, non-volatile storage media such as fixed or removable magnetic, optical, or semiconductor-based media may be provided to store executable code and related data (or receivable within such system to enable receipt of such executable code and related data), while volatile storage media such as static or dynamic random access memory (RAM) is provided to run-time variable data.

### Example Generation of Relative Camera Positions Between Multiple Poses

With reference to FIG. 4, a method for generating relative camera positions between multiple poses in accordance with another embodiment is described that eliminates the need to generate a fundamental matrix from multiple images. FIG. 4 illustrates a sequence of sensor poses in which an overlayed coordinate system is tracked from image to image to determine the spatial coordinates of the sensor in accordance with an embodiment of the present disclosure.

Referring to FIG. 4, a sensor (e.g., sensor 200) captures multiple images of an object (e.g., object 100) from sensor repositioning. The repositioning provides the sensor with an ability to generate images at different poses or viewpoints. These different images are used to compute the relative sensor position between the different poses. In the context of the present example, a coordinate system, in this case, a Cartesian X,Y,Z system 525 is imagined to emanate from the object’s center. In pose 2, the imagined coordinate system 525 is shown with direction and length of the X and Y axis but since the Z axis is emanating directly out of the object, the Z axis has no observable length although the direction is known. In pose 1, since the sensor is at a different position, the X and Y axes are transformed and have different lengths and an angle that is no longer 90 degrees. From these changes to the X, Y axes, the Z axis can be estimated, and a coordinate system can be obtained between the poses to derive the sensor displacement.

### Example Sensor Displacement Calculation From Overlaid Coordinate System

FIG. 8 is a flow diagram 900 illustrating a set of operations for calculating the positional difference of a sensor based upon overlaid coordinate systems differences between different images. The processing described with reference to FIG. 8 may be performed by a combination of the various processing stages, estimators, transformers and the like shown in FIGS. 1 and 2. The processing described with reference to FIG. 8 may be collocated with an imaging device that captured one or both of the two images or may be performed by a computing element, device, or system separate from a first imaging device that captured a first of the two images and a second imaging device that captured a second of the two images.

At block 901, a first image (e.g., image 1) of an object is received as an input from a sensor (e.g., sensor 200). As discussed above, the object may be a known object (e.g., a plate, a bowl, a cup, or the like) having a known shape (e.g., a circle). The first image may be in the form of raw image data representing an objective scene containing the object. Depending on the particular implementation, the first image may represent a may represent a digital photograph, a digital image, or a single frame extracted from a digital video.

At block 902 the object is detected. This may be by a CNN or other methods.

At block 903, a coordinate system is generated based upon the type of object (e.g. circle, square, etc...) and the appearance of the object in the image. As an example, while a plate is circular, the appearance of the plate in the image may be that of an ellipse. Consequently, a generated coordinate system would take into account the deformation. In one embodiment, the generation of the coordinate system is performed by a CNN.

At block 904, a second image is generated by the sensor which has moved from its position in block 901.

At block 905, the same coordinate system generation method is followed as in block 903.

At block 906, the coordinate system generated in block 903 is compared to the coordinate system generated in block 905 and the differences computed.

At block 907 the displacement of the sensor positions between the taking of the first image and the second image is computed from the coordinate system differences.

### Example Use of Coordinate System Changes to Derive an Estimated Pose

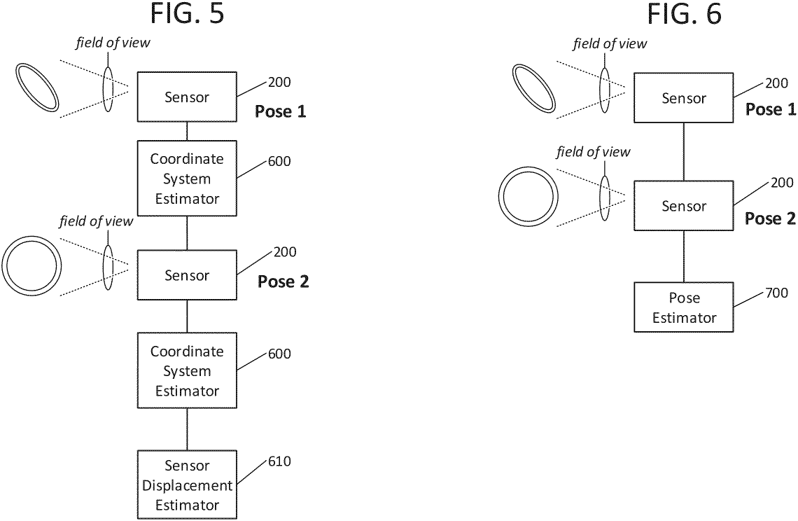

FIG. 5 illustrates an example of operations using coordinate system changes to derive an estimated pose in accordance with an embodiment of the present disclosure. In the context of the present example, a sensor (e.g., sensor 200) images an object at one pose. A coordinate system estimator 600 establishes a coordinate system for the object and its orientation based upon identifying the object and then crafting a coordinate system onto that object and at its current view. At a second pose, the sensor images the same object and similarly uses the coordinate system estimator 600 to establish a second coordinate system for the object and its orientation at the second pose. The first and second estimated coordinate systems are then forwarded to a sensor displacement estimator 610 to estimate the displacement of the sensor between pose 1 and pose 2.

### Example Use of Change of Object Size and/or Appearance

In another embodiment, the estimate of the relative distance between sensor poses can be obtained based upon the change of the object size and appearances extracted from the images at different poses. FIG. 6 illustrates images captures from two poses which are then used by a pose estimator 700 specifically designed to first identify an object within a pose and then with the input of a second image of the same object from a second pose, generate the difference between the first pose and the second pose. The pose estimator 700 may comprise a CNN in which specific objects shapes are trained. For example, the pose estimator may be trained to generate poses for specific shapes such as, but not limited to, circles, squares, cubes, and triangles.

To facilitate the correct identification of an object, a sensor may incorporate the use of information from a positional sensor (e.g., an Inertial Measurement Unit, a gyroscope, an accelerometer, or the like) to ensure that the sensor is taking an image of the object straight on so that the object in the image is representative of a standard shape. For example, when a plate is imaged from directly above, it appears as a circle and therefore can be used to correctly identify the object as a circle. A straight-on example is shown FIG. 4, Image 1 515.

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

The various methods and techniques disclosed herein may be implemented through execution of one or more a sequences of instructions (e.g., software program(s)) within a processing unit (e.g., processing unit 401), by dedicated hardware (e.g., implemented within an application-specific integrated circuit (ASIC), or programmed on a programmable hardware device such as a field-programmable gate array (FPGA), or by any combination programmed processor(s) and dedicated hardware. If a purely hardware-based execution engine is provided, the processing unit 401 and related circuitry may be omitted from computing element 400.

Any of the various methodologies disclosed herein and/or user interfaces for configuring and managing same may be implemented by machine execution of one or more sequences instructions (including related data necessary for proper instruction execution). Such instructions may be recorded on one or more computer-readable media for later retrieval and execution within one or more processors of a special-purpose or general-purpose computing system or consumer electronic device or appliance, for example, the computing element, system, device or appliance described in reference to FIG. 3.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 910. Volatile media includes dynamic memory, such as main memory 906. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a method comprising: receiving a plurality of images of an objective scene containing an object, wherein the plurality of images are captured from different viewpoints; estimating at least one of a relative rotation or translation of the object between a first image of the plurality of images and a second image of the plurality of images; estimating a transform mapping between the first image and the second image based on the at least one of a relative rotation or translation; and calculating a fundamental matrix between the first image and the second image based on the transform mapping.

Example 2 includes the subject matter of Example 1, further comprising: detecting the object within the first image; generating a first transform of a first pose of the object within the first image to a first standard pose of a plurality of standard poses of the object; generating a second transform of a second pose of the object within the second image to a second standard pose of the plurality of standard poses; and determining a planar rotation between the first standard pose and the second standard pose.

Example 3 includes the subject matter of Example 2, wherein said detecting is based on a known shape of the object when viewed in any of the plurality of standard poses of the object.

Example 4 includes the subject matter of Example 2, wherein at least one of the first transform or the second transform comprises an affine transformation.

Example 5 includes the subject matter of any of Examples 1-4, wherein the first image and the second image were captured by different image sensors.

Some embodiments pertain to Example 6 that includes a method comprising: receiving a plurality of images of an objective scene containing an object, wherein the plurality of images are captured by a sensor from different viewpoints; estimating one or more differences between a first coordinate system associated with the object in a first image of the plurality of images and a second coordinate system associated with the object in a second image of the plurality of images; and determining a displacement between a first position of the sensor from which the first image was captured and a second position of the sensor from which the second image was captured based on the one or more differences.

Example 7 includes the subject matter of Example 6, wherein the one or more differences comprise at least one of relative rotations or dimensions between the first coordinate system and the second coordinate system.

Example 8 includes the subject matter of Example 6 or 7, wherein the object has a known shape when viewed in a standard pose of the object and wherein the method further comprises: detecting the object within the first image; and associating the first coordinate system with the object within the first image by generating the first coordinate system based on a type of the object and a first deformation of a shape of the object within the first image from the known shape in which an origin of the first coordinate system corresponds to a center of the object.

Example 9 includes the subject matter of any of Examples 6-8, further comprising: detecting the object within the second image; and associating the second coordinate system with the object within the second image by generating the second coordinate system based on the type of the object and a second deformation of the shape of the object within the second image from the known shape in which an origin of the second coordinate system corresponds to the center of the object.

Example 10 includes the subject matter of any of Examples 6-9, wherein the first coordinate system and the second coordinate system comprise Cartesian coordinate systems for a three-dimensional (3D) space.

Some embodiments pertain to Example 11 that includes a device comprising: one or more processing resources; and instructions that when executed by the one or more processing resources cause the device to: receive a plurality of images of an objective scene containing an object, wherein the plurality of images are captured by a sensor from different viewpoints; estimate one or more differences between a first coordinate system associated with the object in a first image of the plurality of images and a second coordinate system associated with the object in a second image of the plurality of images; and determine a displacement between a first position of the sensor from which the first image was captured and a second position of the sensor from which the second image was captured based on the one or more differences.

Example 12 includes the subject matter of Example 11, wherein the one or more differences comprise at least one of relative rotations or dimensions between the first coordinate system and the second coordinate system.

Example 13 includes the subject matter of Example 11 or 12, wherein the object has a known shape when viewed in a standard pose of the object and wherein the instructions further cause the device to: detect the object within the first image; and associate the first coordinate system with the object within the first image by generating the first coordinate system based on a type of the object and a first deformation of a shape of the object within the first image from the known shape in which an origin of the first coordinate system corresponds to a center of the object.

Example 14 includes the subject matter of any of Examples 11-13, wherein the instructions further cause the device to: detect the object within the second image; and associate the second coordinate system with the object within the second image by generating the second coordinate system based on the type of the object and a second deformation of the shape of the object within the second image from the known shape in which an origin of the second coordinate system corresponds to the center of the object.

Example 15 includes the subject matter of any of Examples 11-15, wherein the first coordinate system and the second coordinate system comprise Cartesian coordinate systems for a three-dimensional (3D) space.

Example 16 includes the subject matter of any of Examples 11-16, further comprising the sensor.

Example 17 includes the subject matter of Example 16, wherein the device comprises a smartphone.

Example 18 includes the subject matter of any of Examples 11-16, wherein the device comprises a computer system separate from a device having the sensor.

Some embodiments pertain to Example 19 that includes an apparatus that implements or performs a method of any of Examples 1-5.

Some embodiments pertain to Example 20 that includes an apparatus that implements or performs a method of any of Examples 6-10.

Some embodiments pertain to Example 21 that includes an apparatus comprising means for performing a method as claimed in any of Examples 1-5.

Some embodiments pertain to Example 22 that includes an apparatus comprising means for performing a method as claimed in any of Examples 6-10.

Some embodiments pertain to Example 23 that includes at least one machine-readable medium comprising a plurality of instructions, when executed on a computing device, implement or perform a method or realize an apparatus as described in any preceding Example.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving a plurality of images of an objective scene containing an object, wherein the plurality of images are captured from different viewpoints;
estimating at least one of a relative rotation or translation of the object between a first image of the plurality of images and a second image of the plurality of images;
estimating a transform mapping between the first image and the second image based on the at least one of a relative rotation or translation; and
calculating a fundamental matrix between the first image and the second image based on the transform mapping.

2. The method of claim 1, further comprising:
detecting the object within the first image;
generating a first transform of a first pose of the object within the first image to a first standard pose of a plurality of standard poses of the object;
generating a second transform of a second pose of the object within the second image to a second standard pose of the plurality of standard poses; and
determining a planar rotation between the first standard pose and the second standard pose.

3. The method of claim 2, wherein said detecting is based on a known shape of the object when viewed in any of the plurality of standard poses of the object.

4. The method of claim 2, wherein at least one of the first transform or the second transform comprises an affine transformation.

5. The method of claim 1, wherein the first image and the second image were captured by different image sensors.

6. A method comprising:
receiving a plurality of images of an objective scene containing an object, wherein the plurality of images are captured by a sensor from different viewpoints;
estimating one or more differences between a first coordinate system associated with the object in a first image of the plurality of images and a second coordinate system associated with the object in a second image of the plurality of images; and
determining a displacement between a first position of the sensor from which the first image was captured and a second position of the sensor from which the second image was captured based on the one or more differences.

7. The method of claim 6, wherein the one or more differences comprise at least one of relative rotations or dimensions between the first coordinate system and the second coordinate system.

8. The method of claim 6, wherein the object has a known shape when viewed in a standard pose of the object and wherein the method further comprises:
detecting the object within the first image; and
associating the first coordinate system with the object within the first image by generating the first coordinate system based on a type of the object and a first deformation of a shape of the object within the first image from the known shape in which an origin of the first coordinate system corresponds to a center of the object.

9. The method of claim 6, further comprising:
detecting the object within the second image; and
associating the second coordinate system with the object within the second image by generating the second coordinate system based on the type of the object and a second deformation of the shape of the object within the second image from the known shape in which an origin of the second coordinate system corresponds to the center of the object.

10. The method of claim 9, wherein the first coordinate system and the second coordinate system comprise Cartesian coordinate systems for a three-dimensional (3D) space.

11. A device comprising:
one or more processing resources; and
instructions that when executed by the one or more processing resources cause the device to:
receive a plurality of images of an objective scene containing an object, wherein the plurality of images are captured by a sensor from different viewpoints;
estimate one or more differences between a first coordinate system associated with the object in a first image of the plurality of images and a second coordinate system associated with the object in a second image of the plurality of images; and
determine a displacement between a first position of the sensor from which the first image was captured and a second position of the sensor from which the second image was captured based on the one or more differences.

12. The device of claim 11, wherein the one or more differences comprise at least one of relative rotations or dimensions between the first coordinate system and the second coordinate system.

13. The device of claim 11, wherein the object has a known shape when viewed in a standard pose of the object and wherein the instructions further cause the device to:
detect the object within the first image; and
associate the first coordinate system with the object within the first image by generating the first coordinate system based on a type of the object and a first deformation of a shape of the object within the first image from the known shape in which an origin of the first coordinate system corresponds to a center of the object.

14. The device of claim 11, wherein the instructions further cause the device to:
detect the object within the second image; and
associate the second coordinate system with the object within the second image by generating the second coordinate system based on the type of the object and a second deformation of the shape of the object within the second image from the known shape in which an origin of the second coordinate system corresponds to the center of the object.

15. The device of claim 14, wherein the first coordinate system and the second coordinate system comprise Cartesian coordinate systems for a three-dimensional (3D) space.

16. The device of claim 11, further comprising the sensor.

17. The device of claim 16, wherein the device comprises a smartphone.
